(19) United States
(12) Patent Application Publication
(10) Pub. No.: US 2003/0094906 A1
(43) Pub. Date: May 22, 2003

(54) Capacitively coupled fluorescent lamp package

(76) Inventors: Chin Chang, Agoura Hills, CA (US); Gert W. Bruning, Sleepy Hollow, NY (US)

Correspondence Address: FRANK C. NICHOLAS, CARDINAL LAW GROUP, Suite 2000, 1603 Orrington Avenue, Evanston, IL, 60201, US

(21) Appl. No.: 10/330,951

(22) Filed: Dec. 27, 2002

Related U.S. Application Data
(63) Continuation-in-part of application No. 09/814,603, filed on Mar. 22, 2001.

(51) Int. Cl. H05B 37/02

(52) U.S. Cl. 315/209 CD; 315/224

(57) ABSTRACT

A fluorescent lamp having a capacitive coupling structure in the form of cylindrical ceramic tubes is packaged with an inverter circuit for driving the fluorescent lamp and supply nodes for applying a supply voltage to the inverter circuit. The inverter circuit can be a conventional inverter circuit, such as, for example, current-fed push-pull, voltage-fed push-pull, active clamped Flyback, and voltage-fed half-bridge inverter circuits.

### RELATED APPLICATIONS

This application claims priority under 35 U.S.C. §120 of U.S. patent application Ser. No. 09/814,603, filed Mar. 22, 2001.

### BACKGROUND OF THE INVENTION

1. Technical Field

The present disclosure relates generally to lighting systems. More specifically, the present disclosure relates to a capacitively coupled fluorescent lamp package having a capacitively coupled fluorescent lamp and an inverter circuit.

2. Background of the Related Art

Cold cathode fluorescent lamps (CCFL) are widely used to backlight liquid crystal displays (LCD) and for other applications. Different electronic drivers or inverter circuits, for example, current-fed push-pull, voltage-fed push-pull, active clamped Flyback, and voltage-fed half-bridge inverter circuits, have been designed to operate CCFL lamps in high operating frequencies. A typical frequency range is between 20 kHz and 100 kHz. In this way a high frequency voltage is applied in a discharge space within a discharge vessel or tube of the CCFL forming a discharge.

To increase the illuminance of the CCFL, the gas pressure of the rare gas which fills the discharge vessel or tube is increased. After increasing the gas pressure of the rare gas, the current required for discharge is not sufficient if the voltage applied to the CCFL and the high frequency of the voltage are not increased. Therefore, in order to increase the illuminance or lamp power of the CCFL, not only must the gas pressure of the rare gas be increased, but also the voltage and current applied to the CCFL. However, when the applied voltage is increased, there is the danger of discharge creeping on the outer surface of the discharge vessel which can lead to an insulation breakdown of the CCFL.

To overcome the disadvantages of conventional CCFLs having two relatively heavy nickel-plated iron rectangular tabs serving as electrodes, a capacitively coupled fluorescent lamp has been designed with a capacitive coupling structure in the form of a pair of cylindrical ceramic tubes. Typically, the cylindrical ceramic tubes have an inner diameter of 2.5 mm, an outer diameter of 3.5 mm and a length of 10 mm. Such ceramic tubes with certain dielectric constant and geometry effectively form series capacitance with the positive column of the lamp. The capacitance is not significantly dependent on frequency. With proper material selection and construction, such series capacitance could be designed for the benefit of the electronic driver.

Due to the improvement of the cathodes, the lamp current is increased dramatically, without having to increase the pressure of the filled gas and the voltage applied to the lamp. In fact, when compared to conventional CCFLs, to deliver the same lamp power, the voltage applied to the capacitively coupled fluorescent lamp is less than the voltage applied to conventional CCFLs.

Further, as an effect, the equivalent lamp impedance is greatly reduced. For example, in a preferred design for the capacitively coupled fluorescent lamp, the lamp voltage is 450 V and the lamp current is 20 mA at 50 kHz. Hence, the lamp impedance is approximately 22.5 kOhm compared with approximately 115 Kohm for conventional CCFLs. Therefore, the capacitively coupled fluorescent lamp overcomes the problems associated with the prior art and also offers several advantages over conventional CCFLs.

There is a need to improve the capacitively coupled fluorescent lamp to provide a capacitively coupled fluorescent lamp package which is designed for installation in an electrical device, especially within an electrical device having an LCD display which requires backlighting.

### SUMMARY OF THE INVENTION

In accordance with the present disclosure, a capacitively coupled fluorescent lamp package is provided which obviates the problems associated with the prior art.

A capacitively coupled fluorescent lamp package of the present invention includes a fluorescent lamp having a capacitive coupling structure in the form of cylindrical ceramic tubes. The lamp package further includes an inverter circuit for driving the florescent lamp and supply nodes for applying a supply voltage to the inverter circuit. The inverter circuit can be a conventional inverter circuit, such as, for example, a current-fed push-pull, a voltage-fed push-pull, an active clamped Flyback, and a voltage-fed half-bridge inverter circuit.

Specifically, the present invention provides a capacitively coupled fluorescent lamp package including a fluorescent lamp; an inverter circuit for driving the lamp; and supply nodes for receiving a supply voltage.

The present disclosure further provides a method for manufacturing a capacitively coupled fluorescent lamp package. The method includes the steps of providing a capacitively coupled fluorescent lamp; providing an inverter circuit for driving the lamp; and providing supply nodes for applying a supply voltage to the inverter circuit. The method further includes the step of providing a housing for fully enclosing the lamp, the inverter circuit and partially enclosing the supply nodes.

### BRIEF DESCRIPTION OF THE DRAWINGS

FIG. 1 illustrates a prior art capacitively coupled fluorescent lamp;

FIG. 2 is a block diagram of a capacitively coupled fluorescent lamp package according to the present invention;

FIG. 3 is a schematic diagram of a voltage-fed half-bridge inverter circuit driving the capacitively coupled fluorescent lamp; and

FIG. 4 is a block diagram of an alternate capacitively coupled fluorescent lamp package according to the present invention.

### DETAILED DESCRIPTION OF THE PRESENTLY PREFERRED EMBODIMENTS

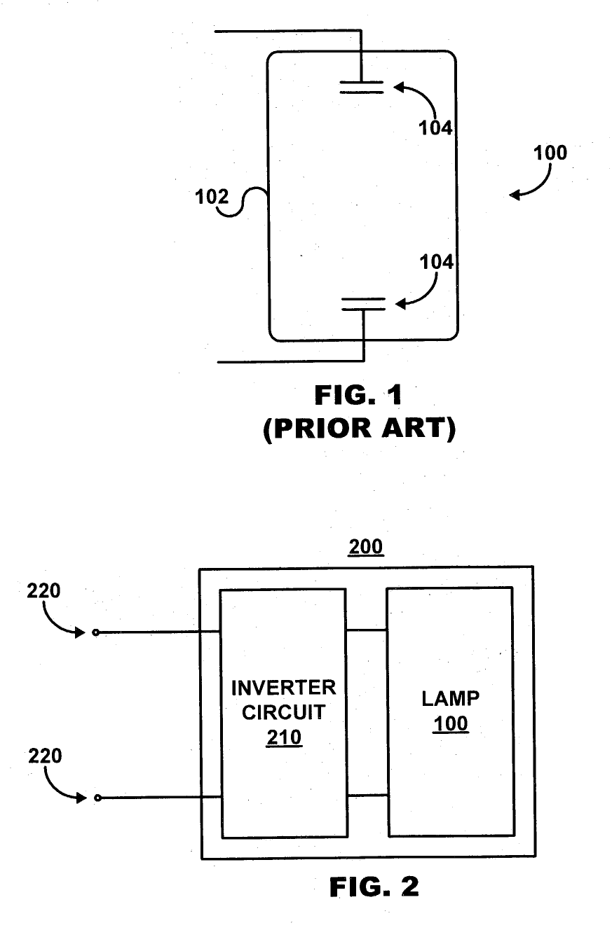

A preferred embodiment of the presently disclosed capacitively coupled fluorescent lamp package will now be described in detail with reference to FIGS. 1 and 2. While the embodiment disclosed herein is designed for backlighting a liquid crystal display (LCD), the presently disclosed embodiment can be used in other applications.

With reference to FIG. 1, there is shown a prior art capacitively coupled fluorescent lamp designated generally by reference numeral 100. The capacitively coupled fluorescent lamp 100 includes a discharge vessel or tube 102 and cylindrical ceramic tubes or capacitive coupling structures 104, instead of the conventional cathodes, within the discharge vessel 102. Typically, the cylindrical ceramic tubes 104 have an inner diameter of approximately 2.5 mm, an outer diameter of approximately 3.5 mm and a length of approximately 10 mm.

The cylindrical ceramic tubes 104 of the capacitively coupled fluorescent lamp 100 cause the current applied to the lamp 100 to increase by approximately 100% without having to increase the pressure of the filled gas within a discharge vessel or tube 102 and the voltage applied to the lamp 100.

In a preferred design for the capacitively coupled fluorescent lamp 100, the lamp voltage is approximately 450 V. Further, the lamp current is approximately 20 mA at an operating frequency of approximately 50 kHz. Hence, the lamp impedance is approximately 22.5 kOhm compared with approximately 115 Kohm for conventional CCFLs.

With reference to FIG. 2, there is shown a block diagram of a capacitively coupled fluorescent lamp package according to the present disclosure. The capacitively coupled fluorescent lamp package designated generally by reference numeral 200 includes the capacitively coupled fluorescent lamp 100 having the discharge vessel 102 and cylindrical ceramic tubes 104. The lamp package 200 further includes an electronic driver or inverter circuit 210 for driving the lamp 100 and supply nodes 220 for receiving a supply voltage from a voltage or power supply (not shown). The supply voltage is approximately 450 V. Preferably, the inverter circuit 210 supplies a 20 kHz and 100 kHz driving signal to the capacitively coupled fluorescent lamp 100.

The inverter circuit 210 is a conventional inverter circuit, such as, for example, current-fed push-pull, voltage-fed push-pull, active clamped Flyback, and voltage-fed half-bridge inverter circuits, used in conventional CCFLs.

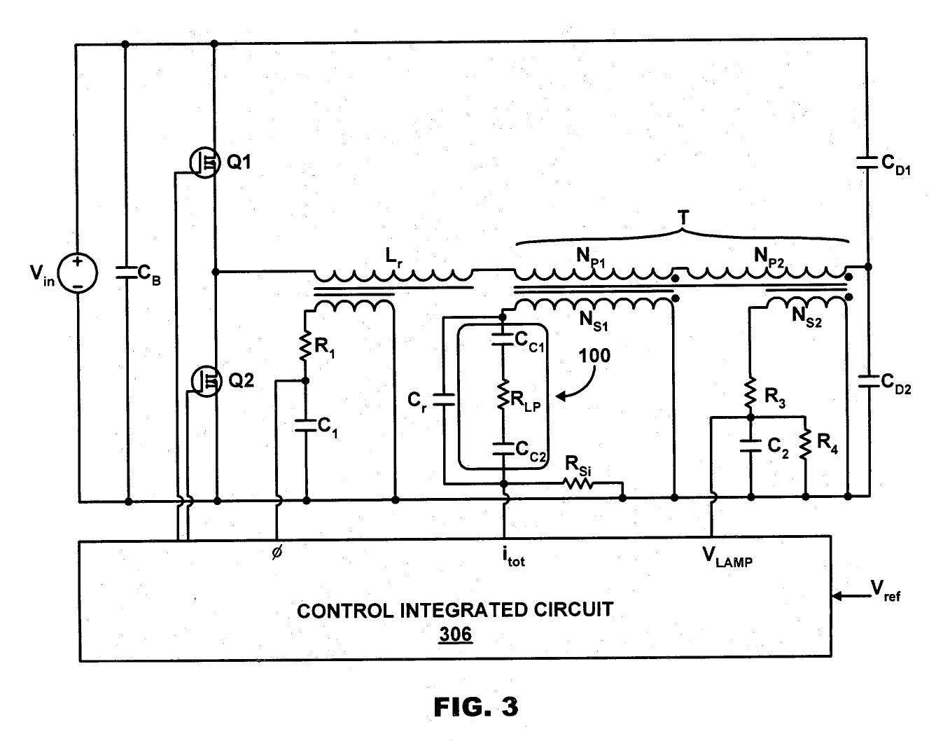

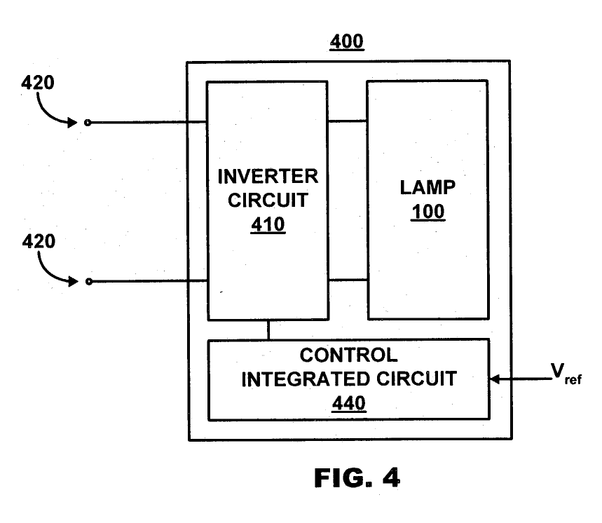

As shown in FIG. 3, one preferred inverter circuit for incorporation within the lamp package 200 is the voltage-fed half-bridge inverter circuit operated by an input voltage vᵢₙ and including a conventional arrangement of a switch pair Q1 and Q2, a buffer capacitor C_{B}, and a DC block pair C_{D1} and C_{D2}. The voltage-fed half-bridge inverter circuit is controlled by a control integrated circuit 306, which is operated by a reference voltage v_{ref}.

A resonant inductor Lᵣ is coupled between the switch pair Q1 and Q2, and further coupled to a phase sensing circuit including a conventional arrangement of a resistor R₁ and a capacitor C₁ as shown. The phase sensing circuit is further coupled to a phase input ø of control integrated circuit 306 that is conventionally utilized by control integrated circuit 306 to control the voltage-fed half-bridge inverter circuit.

A transformer T includes a conventional arrangement of a pair of primary windings N_{P1} and N_{P2}, and a pair of secondary windings N_{S1} and N_{S2} as shown. The lamp 100 includes the cylindrical ceramic tubes designated as C_{C1} and C_{C2}, and a resistor R_{LP} is shown to represent the electrical characteristic of the arc of lamp 100. The lamp 100 is coupled between secondary winding N_{S1} and a total current input iₜₒₜ of control integrated circuit 306 that is conventionally utilized by control integrated circuit 306 to control the voltage-fed half-bridge inverter circuit. A sense resistor R_{Si} is also coupled to the total current input iₜₒₜ of control integrated circuit 306 as shown. Lamp 100 is employed to backlight a LCD panel. In the application of the lamp in the field of backlighting, a resonant capacitance is formed by an equivalent shield parasitic capacitance shown as capacitor C_{SH} and an equivalent output interwinding capacitance of transformer T. In other applications, a resonant capacitance can be formed by conventional methods.

A lamp voltage detection circuit includes a conventional arrangement of a resistor R3 coupled to secondary winding N_{S2} and a voltage lamp input V_{LAMP} of control integrated circuit 360 that is conventionally utilized by control integrated circuit 306 to control the voltage-fed half-bridge inverter circuit. The lamp voltage detection circuit further includes a parallel coupling of a capacitor C2 and a resistor R4 that is coupled to the voltage lamp input V_{LAMP} of control integrated circuit 360.

In operation, the ballasting elements of lamp 100 are primarily controlled the cylindrical ceramic tubes designated as C_{C1} and C_{C2} in cooperation with resonant inductor Lr and the resonant capacitance. Those having ordinary skill in the art will appreciate additional electrical components that may be employed in the ballasting of lamp 100.

With reference to FIG. 4, there is shown a block diagram of an alternate embodiment of the capacitively coupled fluorescent lamp package according to the present disclosure. The capacitively coupled fluorescent lamp package designated generally by reference numeral 400 is similar to the lamp package 200 described above. Accordingly, the lamp package 400 includes the capacitively coupled fluorescent lamp 100 having the discharge vessel 102 and cylindrical ceramic tubes 104.

The lamp package 400 further includes an electronic driver or inverter circuit 410 for driving the lamp 100 and supply nodes 420 for receiving a supply voltage from a voltage or power supply (not shown). The supply voltage of the lamp package 400 is approximately 450 V. Preferably, the inverter circuit 410 supplies a 20 kHz and 100 kHz driving signal to the capacitively coupled fluorescent lamp 100.

In backlighting an LCD, the lamp package 200 is installed within a system having the LCD, such as a laptop computer, and the supply nodes 220 are connected to the voltage or power supply for providing a supply voltage. The inverter circuit 210 is then powered by the supply voltage. Accordingly, the inverter circuit 210 transmits drive signals to the capacitively coupled fluorescent lamp 100 causing the lamp 100 to achieve luminance for backlighting the LCD.

The present disclosure also provides a method for manufacturing the capacitively coupled fluorescent lamp packages 200, 400. The method includes the steps of providing a capacitively coupled fluorescent lamp 100; providing an inverter circuit, such as the inverter circuits 210, 410, for driving the lamp 100; and providing supply nodes, such as supply nodes 220, 420, for applying a supply voltage to the inverter circuit.

It is contemplated to also provide a housing for fully enclosing the lamp 100, the inverter circuit and partially enclosing the supply nodes.

Preferably, the inverter circuit is selected from the group consisting of current-fed push-pull, voltage-fed push-pull, active clamped Flyback, and voltage-fed half-bridge inverter circuits.

It will be understood that various modifications may be made to the embodiments disclosed herein and that the above description should not be construed as limiting, but merely as exemplifications of preferred embodiments. Those skilled in the art will envision other modifications within the scope and spirit of the claims appended hereto.

1. A capacitively coupled fluorescent lamp package, comprising:
a fluorescent lamp including a capacitive coupling structure;
an inverter circuit for driving said fluorescent lamp; and
supply nodes for applying a supply voltage to said inverter circuit.

2. The capacitively coupled fluorescent lamp package of claim 1, wherein said inverter circuit is selected from a group consisting of a current-fed push-pull, a voltage-fed push-pull, an active clamped Flyback, and a voltage-fed half-bridge inverter circuits.

3. The capacitively coupled fluorescent lamp package of claim 1, wherein a ballasting of said fluorescent lamp is primarily controlled by said capacitive coupling structure.

4. The capacitively coupled fluorescent lamp package of claim 1, further comprising: a resonant inductor for cooperating in the ballasting of said fluorescent lamp.

5. The capacitively coupled fluorescent lamp package of claim 1, wherein said fluorescent lamp includes a discharge vessel and cylindrical ceramic tubes within the discharge vessel, said cylindrical ceramic tubes constituting said capacitive coupling structure.

6. The capacitively coupled fluorescent lamp package of claim 5, wherein
a ballasting of said fluorescent lamp is primarily controlled by said cylindrical ceramic tubes.

7. The capacitively coupled fluorescent lamp package of claim 6, further comprising:
a resonant inductor for cooperating in the ballasting of said fluorescent lamp.

8. The capacitively coupled fluorescent lamp package of claim 3, wherein said cylindrical ceramic tubes have an inner diameter of approximately 2.5 mm, an outer diameter of approximately 3.5 mm, and a length of approximately 10 mm.

9. The capacitively coupled fluorescent lamp package of claim 1, wherein said inverter circuit supplies a 20 kHz and 100 kHz driving signal to said fluorescent lamp.

10. The capacitively coupled fluorescent lamp package of claim 1, wherein the supply voltage is approximately 450 V.

11. The capacitively coupled fluorescent lamp package of claim 1, wherein said fluorescent lamp has a lamp current of approximately 20 mA and an operating frequency of approximately 50 kHz.

12. The capacitively coupled fluorescent lamp package of claim 1, wherein said fluorescent lamp has a lamp impedance of approximately 22.5 kOhm.

13. The lamp package of clam 1, further comprising:
an integrated circuit for controlling said inverter circuit.

14. A method for manufacturing a capacitively coupled fluorescent lamp package, the method comprising the steps of:
providing a fluorescent lamp including a capacitive coupling structure;
providing an inverter circuit for driving said fluorescent lamp; and
providing supply nodes for applying a supply voltage to said inverter circuit.

15. The method of claim 14, further comprising:
providing a housing for fully enclosing said fluorescent lamp and said inverter circuit, and for partially enclosing said supply nodes.

16. The method of claim 14, further comprising:
providing an integrated circuit for controlling said inverter circuit.

17. The method of claim 14, further comprising:
selecting said inverter circuit from a group consisting of a current-fed push-pull, a voltage-fed push-pull, an active clamped Flyback, and a voltage-fed half-bridge inverter circuits.
